(19) United States
(12) Patent Application Publication
(10) Pub. No.: US 2024/0220810 A1
(43) Pub. Date: Jul. 4, 2024

(54) USER SELECTION PREDICTION BASED ON GRAPH NEURAL NETWORK AND USER SELECTION SEQUENCE

(71) Applicant: Home Depot Product Authority, LLC, Atlanta, GA (US)

(72) Inventors: Amin Javari, Atlanta, GA (US); Yu Wang, Vanderbilt, TN (US); Janani Balaji, Atlanta, GA (US); Xiquan Cui, Atlanta, GA (US)

(21) Appl. No.: 18/431,370

(22) Filed: Feb. 2, 2024

Related U.S. Application Data
(63) Continuation of application No. PCT/US24/10184, filed on Jan. 3, 2024.
(60) Provisional application No. 63/436,864, filed on Jan. 3, 2023.

(51) Int. Cl. G06N 3/091; G06N 5/02

(52) U.S. Cl. CPC G06N 3/091; G06N 5/02

(57) ABSTRACT

A method for predicting a next user selection in an electronic user interface includes receiving a sequence of user selections through the electronic user interface, determining a context embedding vector according to the sequence of user selections, querying a knowledge graph, the knowledge graph respective of a plurality of possible user selections, with the context embeddings vector, to obtain a knowledge-enhanced representation of the sequence, determining, with a graph neural network respective of the knowledge graph, based on the knowledge-enhanced representation, a respective representation of each selection in the sequence of user selections, and determining a predicted next user selection according to the respective representations of the selections in the sequence of user selections.

### CROSS-REFERENCE TO RELATED APPLICATION

This application claims the benefit of priority to U.S. provisional application No. 63/436,864, filed Jan. 3, 2023, which is hereby incorporated by reference in its entirety.

### TECHNICAL FIELD

This disclosure generally relates to prediction of a next user action in an electronic interface given a sequence of prior user actions, including a particular training approach for a machine learning model for such predictions.

### BACKGROUND

As users interact with a website, predictions of website user behavior may be utilized in numerous ways. For example, a user's browsing sequence may be used to predict (and therefore recommend) the user's next desired browsing action. In another example, a user's purchase sequence may be used to predict (and therefore recommend) a next product for the user. Recommender systems aim to alleviate information overload by aiding users to efficiently discover items of interest in different contexts. In this regard, the recommender system learns users' preferences from historical user-item interactions and then recommends items aligned with the learned preferences of the user.

### BRIEF DESCRIPTION OF THE DRAWINGS

FIG. 1 is a diagrammatic view of an example system for providing a recommendation to a user based on a sequence of actions of the user.

FIG. 2a is a graphical diagram illustrating an example knowledge graph generated by the sequential recommendation system 104 of FIG. 1.

FIG. 2b is a block diagram illustrating an example of the next item prediction performed by the sequential recommendation system 104 of FIG. 1.

FIG. 3 is a flow chart illustrating an example method for determining and outputting a predicted next user action in an electronic user interface.

FIG. 4 is a flow chart illustrating an example method 300 of predicting a next user action in a session using a knowledge graph.

FIG. 5 is a diagrammatic view of an example embodiment of a user computing environment.

FIG. 6 is a block diagram illustrating an example of the encoding of metadata embeddings, according to some embodiments.

### DETAILED DESCRIPTION

Next item prediction leverages learned users' preferences from historical interactions and recommends items based on these learned preferences. Users' historical actions can be represented, for example, as a sequence evolving over time. Conventional approaches capture the transition patterns embedded in each user sequence and leverages the captured patterns to predict next items that users are likely to interact with. To predict next items, certain conventional approaches utilize short-term transition patterns such as, for example, taking an immediate previous action of the user to make the next item prediction. Other conventional approaches utilize neural network models to capture entire user sequences and to capture long-term transitions to make such predictions. For example, to characterize the intention of the user to predict the next item for a given sequence, transition information between a first item (e.g., flower) and a second item (e.g., sink) may be taken from other sequences. That is, a global graph is constructed using all historical user-item interactions coupled with existing sequential-based models.

These conventional approaches for predicting items typically focuses on improving sequential-based models to capture users' intentions encoded in each sequence. As capturing global transition patterns across different sequences has been demonstrated to be an important step in characterizing users' general interests, these conventional approaches capture these cross-sequence transitions by constructing a global graph and aggregating neighborhood information for each item. However, these constructed global graphs only involve one type of user interactive behavior, and the aggregated neighborhood information cannot vary adaptively according to the unique intention reflected in the context of each user sequence. That is, the constructed graphs used for capturing global transitions generally involve only one single type of edges, which cannot reflect diverse item relations such as, for example, co-views between substitution items and co-purchase between complementary items. In addition, these conventional approaches query neighborhood information without considering the contextual information of each user sequence (e.g., the particular user's intention for the item), which may introduce noise corrupting the user intention. Furthermore, conventional models typically only consider the item ID as a feature, which fails to scale to sequences containing cold-start items. Even when such conventional approaches combine metadata information with item ID, they may only demonstrate a slight performance improvement due to overfitting to item ID, and/or do not consider the cross-sequence transition embedded in the global graph.

Various embodiments of the present disclosure relate to systems, computer-implemented methods, and non-transitory computer readable media for predicting next items that users are likely to interact with by capturing their interests from historical user activities by leveraging a heterogeneous graph-based framework for session recommendation. In this regard, the various embodiments may be configured to generate a knowledge graph (e.g., multiplex graph) by connecting items with multi-typed edges to characterize various user-item interactions. Then, the global transition patterns are exploited by performing sequence-adaptive propagation on the constructed knowledge graph, which adaptively aggregates item neighborhood information considering the user intention/context encoded in the sequence. In addition, different types of item meta-attributes may be integrated in the heterogenous propagation to alleviate the cold-start issue by items with fewer user activities.

The various embodiments of the present disclosure provide improvements to conventional approaches known in the prior art by constructing a heterogeneous knowledge graph that considers different types of item co-relations with users. In addition, one or more embodiments of the present disclosure improves upon the blind propagation of neighborhood information such as in the conventional approaches by providing a sequence-adaptive propagation mechanism to selectively aggregate neighbors' information based on their consistency with the sequence intention rather based only on item similarity. Furthermore, the item embeddings are initialized by integrating different types of item meta-features, which alleviates the cold start issues due to initialization based on item ID in the conventional approaches. In the various embodiments, after sequence-adaptive propagation, the obtained item embeddings are further fed into the sequential-based models to perform session recommendation.

In various embodiments of the present disclosure, the knowledge graph may be a heterogeneous item graph constructed based on historical user-item interactions. The heterogeneous item graph may consider different types of edges based on item co-relations with users. In some embodiments, the heterogeneous item graph may consider one or more different types of edges based on item co-relations with users. In other embodiments, the heterogeneous item graph may consider two different types of edges based on item co-relations with users. In yet other embodiments, the heterogeneous item graph may consider three different types of edges based on item co-relations with users. The different types of edges may include co-view, co-add-to-cart (co-ATC), and co-view-ATC, according to some embodiments. In addition, a model in the various embodiments of the present disclosure may comprise a sequence-adaptive heterogeneous graph propagation layer with a momentum updating mechanism to capture global transition patterns by selectively querying items' neighbors based on sequential contexts. In addition, the various embodiments may be capable of alleviating the cold-start issue by integrating item meta-features and leveraging multi-task learning to provide extra-supervision into item embeddings.

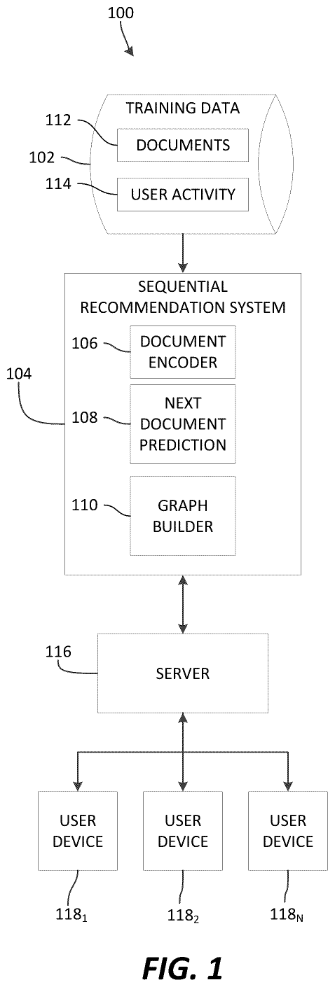

Referring to the drawings, wherein like numerals refer to the same or similar features in the various views, FIG. 1 is a diagrammatic view of an example system 100 for providing a recommendation to a user based on a sequence of actions of the user. The system 100 may include a training data source 102 and a sequential recommendation system 104 that may include one or more functional modules 106, 108, 110 embodied in hardware and/or software. In an embodiment, the functional modules 106, 108, 110 of the sequential recommendation system 104 may be embodied in a processor and a memory (i.e., a non-transitory, computer-readable medium) storing instructions that, when executed by the processor, cause the system to perform the functionality of one or more of the functional modules and/or other functionality of this disclosure.

The training data source 102 may include a set of documents 112 and records of user activity 114. In some embodiments, the documents 112 may be documents specific to or otherwise accessible through a particular electronic user interface, such as a website or mobile application. The user activity 114 may be user activity on the electronic user interface, such as user navigations to the documents, user selections of the subjects of the documents, sequences of user selections of the documents, etc. For example, in some embodiments, the documents 112 may be respective of products and services offered through a website (e.g., where each document is respective of a given product or service), and the user activity 114 may be user interactions with the documents themselves (e.g., user navigations to, clicks on, or examinations of the documents), and/or user interactions with the products and services that are the subjects of those documents (e.g., purchases, additions to cart, etc.).

The functional modules 106, 108, 110 of the sequential recommendation system 104 may include a document encoder 106 that receives, as input, a document, and generates a representation of that document. The representation may be or may include one or more vectors representation of the metadata and/or contents of the document. The document encoder 106 may include a graph neural network or a portion of a graph neural network, in some embodiments.

The functional modules 106, 108, 110 may further include a next document prediction module 108 that receives, as input, one or more document representations (e.g., a sequence of document representations, or a representation of a sequence of documents) and may output one or more predicted next documents, and/or one or more characteristics of one or more predicted next documents. The next document prediction module 108 may include one or more machine learning models or model portions. For example, the next document prediction module 108 may include a transformer-based encoder model portion.

The functional modules 106, 108, 110 may further include a graph builder module 110 that may receive the records of user activity 114 and build or otherwise generate, based on the records, a knowledge graph respective of the records. The knowledge graph may include a plurality of nodes, each of which nodes is representative of a user action or selection (e.g., viewing, adding to cart, or purchasing a given item), and connections between nodes. Each node-to-node connection may be representative of a session-based relationship between connected actions/selections, such as co-views, co-purchases, or co-view purchases, for example. The knowledge graph may be referred to as a multiplex graph, according to some embodiments. The knowledge graph may include therein edge weights normalized based on the total number of co-relationships between any pair of items, as will be further described herein.

The sequential recommendation system 104 may be configured to train one or more machine learning models (e.g., one or more models included in the document encoder 106 and/or next document prediction module 108) using the training data 102. For example, in some embodiments, the document encoder 106 may be a training module configured to train a machine learning module using the documents 112 to enable the model to recognize and predict sequences of user actions based on the metadata and contents of the documents 112 associated with those user actions.

The sequential recommendation system 104 may further be configured to use the trained machine learning model(s) to, given an input of a sequence of user actions, predict the most likely next user action (or multiple such actions). For example, the trained machine learning model may be applied in conjunction with a website to recommend a next document to a user based on that user's sequence of actions on the website. In some embodiments, the trained machine learning model may receive a sequence of products and/or services that a user interacts with, such as by viewing, adding to cart, or purchasing, and may output to the user a predicted product or service, or the characteristics of a predicted product or service, based on that sequence.

The system 100 may further include a server 116 in electronic communication with the sequential recommendation system 104 and with a plurality of user computing devices 1181, 1182, . . . 118x. The server 116 may provide a website, data for a mobile application, or other interface through which the users of the user computing devices 118 may navigate and otherwise interact with the documents 112. In some embodiments, the server 116 may receive a sequence of user actions through the interface, provide the sequence of user actions to the sequential recommendation system 104, receive a next document prediction from the sequential recommendation system 104, and provide the next document prediction to the user (e.g., through the interface).

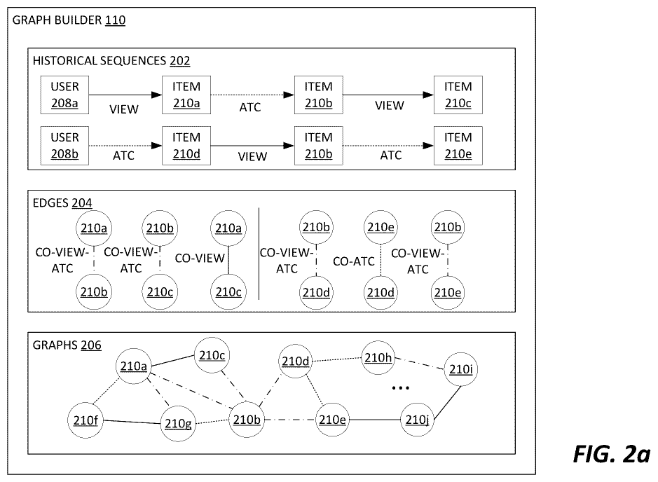

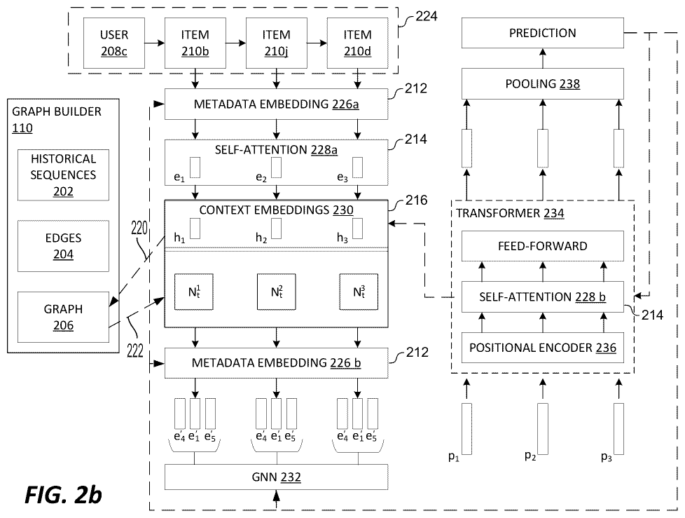

FIG. 2a is a graphical diagram illustrating a non-limiting example of a knowledge graph, and system and process for generating the knowledge graph, using the sequential recommendation system 104 of FIG. 1, according to some embodiments. The sequential recommendation system 104, according to some embodiments, may be configured to extract three types of edges from the users' sequences to construct the knowledge graph such as in graph module 206.

In the sequential recommendation system 104, let S={Sₘ}ₘ₌₁^{M} be the M session sequences with the m^{th} session being Sₘ={vᵢ}ᵢ₌₁^{|S}^{ₘ}^{|}, where vᵢ is the ith item interacted by the user in the session Sₘ. Since each user could sequentially view of add-to-cart (ATC) the item, let τ: V×S→τ be the mapping from the user and sequence to the type interaction where τ={view,ATC}. For example, τ(vᵢ,Sₘ) denotes the type of interaction between the user who generates the sequence Sₘ and the item vᵢ∈Sₘ.

Referring to FIG. 2a, the sequential recommendation system 104 may include a graph builder module 110, and the graph builder module 110 may be configured to obtain the users' historical sequences. In some embodiments, the graph builder module 110 may further include historical sequences module 202. From the users' sequences in historical sequences module 202, the graph builder module 110 may identify items that frequently co-occur together in the sequences (e.g., items that occur in the same sequence). These items may, for example, share certain relationships such as being substitution items or complementary items. For example, a garden hose sprayer is complementary to a garden hose, and the graph builder module 110 may identify these two items in the sequences in historical sequences module 202.

From the sequences in historical sequences module 202, the graph builder module 110 may be configured to extract edges between the items identified as frequently co-occurring together in the sequences. In some embodiments, the graph builder module 110 may include edges module 204 configured to extract edges between the items identified as frequently co-occurring together in the sequences. The edges may correspond to co-view edges, co-add-to-cart (ATC) edges, and co-view-ATC edges, according to some embodiments.

The edges module 204 may extract one type of edge from the historical sequences in historical sequences module 202 based on whether the two items co-occur together in the same sequences. In other embodiments, the edges module 204 may extract two types of edge from the historical sequences in historical sequences module 202 based on whether the two items co-occur together in the same sequences. In yet other embodiments, the edges module 204 may extract three types of edges from the historical sequences in the historical sequences module 202 based on whether the two items co-occur together in the same sequences. As shown in FIG. 2a, based on item 210a through item 210e in sequences associated with user 208a and user 208b, respectively, the edges module 204 extracts edges indicated by a solid line and corresponding to co-views between item pairs, an edge indicated by a first type of dashed line and corresponding to co-add-to-carts (co-ATCs) between item pairs, and an edge indicated by a second type of dashed line and corresponding to co-view-ATCs between item pairs.

Based on the edges determined by edges module 204, the graph builder module 110 may be configured to construct a knowledge graph. In some embodiments, the graph builder module 110 may include graph module 206 configured to construct the knowledge graph based on the edges extracted by the edges module 204 from sequences in historical sequences module 202. The knowledge graph may include a plurality of nodes, each of which nodes is representative of a user action or selection (e.g., viewing, adding to cart, or purchasing a given item), and connections between nodes. For example, as shown in FIG. 2a, the graph includes item 210a through item 210j. Each node-to-node connection may be representative of a session-based relationship between connected actions/selections, such as co-views, co-purchases, or co-view purchases, for example. In some embodiments, the knowledge graph generated by the graph module 206 may be an aggregation of models. That is, for example, the knowledge graph may be an aggregation of a previous iteration graph and the output results of the edges extracted from sequences of users 208a, 208b by the edges module 204 and by graph builder module 110.

Generally, for two items, a higher quantity of co-occurrences of the two items in the same sequence may be indicative of a closer/stronger relationship between the items. In this regard, for example, edges incident to popular items may naturally be assigned higher weightings, which could inform popularity bias. In producing the knowledge graph, the sequential recommendation system 104 and graph builder module 110 may be configured to account for such bias in making the item prediction. In some embodiments, the graph module 206 may be configured to account for such bias in making the item prediction. To account for and compensate for this bias, in some embodiments, the sequential recommendation system 104 may calculate the weight w^{t1,t2} for passing the message from item vⱼ to i←j, vᵢ along the edge of type co-t₁-t₂ by normalizing the total number of co-occurrence of each individual edge based on the degree of its tail node vᵢ, which may be formulated as:

$${w}_{i ← j}^{{t}_{1} , {t}_{2}} = \frac{{Σ}_{m = 1}^{M} 1 ( {v}_{i} ∈ {S}_{m} , {v}_{j} ∈ {S}_{m} , τ ( {v}_{i} , {S}_{m} ) = {t}_{1} , τ ( {v}_{j} , {S}_{m} ) = {t}_{2} )}{{Σ}_{m = 1}^{M} 1 ( {v}_{i} ∈ {S}_{m} , τ ( {v}_{i} , {S}_{m} ) = {t}_{1} )} ,$$

where t₁, t₂∈τ and 1 is an indicator function. Specifically, 1(vᵢ∈Sₘ,vⱼ∈Sₘ,τ(vᵢ,Sₘ)=t₁,τ(vⱼ,Sₘ)=t₂)=1 if both vⱼ and vᵢ belong to the sequence Sₘ, user interacts with vᵢ following type t₁ and interacts with vⱼ following type t₂ in Sₘ. Note that under this definition, the edge is directed in passing messages from vⱼ to vᵢ and hence the importance of neighborhoods may not be symmetric, i.e., w_{i←j}^{t}^{₁}^{,t}^{₂}≠w_{j←i}^{t}^{₁}^{,t}^{₂}. For example, gloves may typically be co-purchased with a lopper as a compatible item for protecting users from injury during use, while items that may frequently be co-purchased with the gloves might not necessarily include the lopper but instead may be co-purchased with other items where the context of wearing gloves may be associated therewith. The sequential recommendation system 104 may then be configured to select the top-k neighbors based on {w_{i←j}^{t}^{₁}^{,t}^{₂}|j∈N^{t}^{₁}^{,t}^{₂}} to be the co-t₁-t₂ neighborhood of item vᵢ in the graph.

FIG. 2b is a block diagram illustrating a non-limiting example of next item prediction performed by the sequential recommendation system 104 of FIG. 1, according to some embodiments.

The sequential recommendation system 104 may obtain a given user sequence, which may be forwarded by the sequential recommendation system 104 through a first metadata embedding layer 226a, and first self-attention layer 228a to obtains the items' context embeddings, which are further used to query 220 corresponding neighbors from the knowledge graph in graph module 206, and which returns 222 the neighbors from the knowledge graph in graph module 206 and/or data associated therewith. Afterwards, the queried neighbors from the knowledge graph may be forwarded through a second metadata embedding layer 226b and graph attention layer to selectively propagate their information to the items in the given user sequence. The propagated item embeddings are then fed into transformer 234 and encoder 236 followed by a pooling layer 238 to obtain the sequence embedding, which may then be used by sequential recommendation system 104 for predicting the next item. In addition, the second metadata embedding layer 226b, and the second self-attention layer 228b in the transformer 234 may be optimized via back-propagation, whereas the first metadata embedding layer 226a, and the first self-attention layer 228a may be updated via momentum update.

With continued reference to FIG. 2b, the sequential recommendation system 104 may include a metadata embedding module 212, a self-attention module 214, and a context embedding module 216. The sequential recommendation system 104 may include the metadata embedding module 212, the metadata embedding module 212 being configured to encode embeddings for an item based on the item's metadata. That is, the metadata embedding module 212 may, for a sequence of items, encode embeddings for the items based on the item's metadata at metadata embedding layer 226a. The metadata embedding module 212 enables items sharing the same attributes to be similarly encoded. Hence, even for cold-start items selected by a user during a sequence, such items may share the same sub-embeddings with already encoded items if they share the same metadata attributes, thereby enabling improved next item recommendation by the sequential recommendation system 104 and alleviating the issue of lower optimalization which may be typically encountered in conventional systems providing item recommendation due to less supervision in training sequences.

Utilizing the metadata encoding module 212, the sequential recommendation system 104 may leverage different encoding techniques to extract different types of item metadata from items. The item metadata may include, but is not limited to, numerical data, categorical data, textual data, other types of metadata, or any combinations thereof. Numerical attributes such as, for example, weight, dimensions, etc., may be directly encoded as a vector value by the metadata encoding layer module 212.

The sequential recommendation system 104 and the metadata encoding module 212 may utilize token-based embedding, where such noisy semantic signals may be avoided since they correspond to different word embeddings relative each other. The final embedding eᵢ of each item vᵢ may be generated by concatenating all different types of feature vectors. In this regard, the metadata embedding module 212 applied by the sequential recommendation system 104 enables items sharing the same or similar attributes to be similarly encoded relative the other item as compared to conventional approaches that encode items based only on item IDs.

The sequential recommendation system 104 may obtain a sequence 218. The sequence 218 may be, for example and as shown in FIG. 2b, associated with user 208c, the sequence 218 including items 210b, 210j, and 210d. The metadata embedding module 212 may obtain the user sequence 218 and the corresponding items therein and encode the embeddings for the items at metadata encoding layer 226a. In this regard, at metadata encoding layer 226a, the module 212 may encode the embeddings for the items 210b, 210j, and 210d. In some embodiments, the document encoder module 106 may include therein the metadata embedding module 212 configured to encode the embeddings for the items based on the item's metadata.

The sequential recommendation system 104 includes the self-attention module 214. After obtaining the item embeddings for all items, the sequential recommendation system 104 may be configured to capture cross-sequence patterns by leveraging a sequence-adaptive propagation mechanism to aggregate items' neighborhood information based on knowledge graph in graph module 206. The sequential recommendation system 104 may adaptively propagate neighborhood information based on the item's unique context defined by that sequence. To adaptively propagate the neighborhood information, the sequential recommendation system 104 may utilize the self-attention module 214, context embedding module 216, or both. In some embodiments, the document encoder module 106 may include the self-attention module 214 and the context embedding module 216.

The sequential recommendation system 104 may, after obtaining all item (e.g., selection) embeddings from metadata embedding layer 226a for the user sequence, apply self-attention module 214 to the items in the user sequence to obtain the context embeddings of the items in the user sequence. In this regard, at self-attention layer 228, after obtaining all item embeddings E∈R^{|V|×d}, the sequential recommendation system 104 may, for each sequence Sₘ, apply the self-attention module 214 to the items to obtain the context embeddings of items in Sₘ. The sequential recommendation system 104 may then utilize these embeddings at the context embedding layer 230 to calculate attention coefficients to query 220 the constructed knowledge graph for corresponding neighbors.

According to some embodiments, the sequential recommendation system 104 and the self-attention module 214 may determine two self-attention layers 228. At a first layer 228a, the self-attention module 214 may be configured to encode the embeddings for calculating context embeddings as eᵢ*. At a second layer 228b, the self-attention module 214 may be configured to encode the embeddings for message-passing as eᵢ^{Δ}. For each item vᵢ in the sequence Sₘ, the context embedding module 214 obtains its context embedding hᵢ^{m,l,*} at layer l by the first self-attention layer 228 a as:

$${h}_{i}^{m , l , *} = {‖}_{h = 1}^{{H}^{l}} {\sum }_{{v}_{k} ∈ {S}_{m}} {w}_{i ← k}^{h , l , *} {V}^{h , l , *} {h}_{k}^{m , l - 1 , *} ,$$

$${w}_{i ← k}^{h , l , *} = \frac{{( {Q}^{h , l , *} {h}_{i}^{m , l - 1 , *} )}^{⊤} ( {K}^{h , l , *} {h}_{k}^{m , l - 1 , *} )}{\sqrt{d / {H}^{l}}} ,$$

∀vᵢ∈Sₘ, Sₘ∈δ, 1∈{1, 2, . . . , L*} where w_{i←l}^{h,l,*} denotes the attention from item vₖ to vᵢ under the head h at layer l, and Q^{h,l,*}, K^{h,l,*}, V^{h,l,*} represent the query, key, and value matrix, respectively, at the head h, layer l of the first attention layer 228 a. H^{l} is the total number of heads at layer, L′ is the number of layers in the first attention layer 228 a and hᵢ^{m,0,*}=eᵢ*.

The context embedding module 216 may be configured to determine the context embeddings for the items in the user sequence. That is, the context embedding module 216 captures each item's unique intention within the context of the specific sequence. After the sequential recommendation system 104 and the context embedding module 216 determines the context embeddings for the items in the sequence at context embeddings layer 230, the sequential recommendation system 104 may be configured to perform heterogeneous graph propagation to query 220 the item's neighborhood information.

According to some embodiments, the sequential recommendation system 104 may query (represented by line 220) the items neighborhood information as:

$${h}_{i}^{m , l , Δ} = \frac{1}{\vert T \vert} {\sum }_{t ∈ T} {‖}_{h = 1}^{{H}^{l}} {\sum }_{{v}_{j} ∈ {N}_{i}^{t}} {w}_{i ← j , t}^{h , l , Δ} {V}_{t}^{h , l , Δ} {h}_{j}^{m , l - 1 , Δ} ,$$

$${w}_{i ← j , t}^{h , l , Δ} = \frac{{( {Q}_{t}^{h , l , Δ} {h}_{i}^{m , *} )}^{⊤} ( {K}_{t}^{h , l , Δ} {h}_{j}^{m , l - 1 , Δ} )}{\sqrt{d / {H}_{t}^{l}}} ,$$

∀vᵢ∈Sₘ, Sₘ∈δ, 1∈{1, 2, . . . , L^{Δ}} where w_{i←j,t}^{h,l,Δ} it denotes the attention from item vⱼ to vᵢ under the head h, edge type t at layer l. Q^{h,l,*}, K^{h,l,*}, V^{h,l,*} represent the query, key, and value matrix, respectively, at the head h, edge type t at layer l of graph neural network (GNN) layer 232. Hₜ^{l} is the total number of heads at layer l and edge type t, L^{Δ} is the number of layers and hᵢ^{m,0,Δ}=eᵢ^{Δ}.

Assuming that the same item vᵢ appears both in the sequence Sₘ and the sequence Sₘ′, then the sequential recommendation system 104 may obtain different context embeddings hᵢ^{m,*}, hᵢ^{m,*} that capture two different intentions of the item vᵢ compatible respectively with sequences Sₘ, Sₘ′. Treating these two different embeddings hᵢ^{m,*}, hᵢ^{m′,*} as the query to trigger the heterogenous propagation would end up with two different embeddings hᵢ^{m,Δ}, hᵢ^{m′,Δ} even for the same neighborhood of vᵢ shared by these two sequences Sₘ, Sₘ′. In this regard, hᵢ^{m,Δ} (hᵢ^{m′,Δ}) would only encode the information from the knowledge graph that is relevant to the item's unique intention defined by its sequence context Sₘ (Sₘ′).

After the sequential recommendation system 104 obtains the propagated embedding hᵢ^{m,Δ}, ∀vᵢ∈Sₘ, the embeddings are fed into transformer 234 at positional encoder 236, followed by a mean pooling layer 238 to obtain the sequence embedding sᵢ. Then, sequential recommendation system 104 may be configured to compute the cross-entropy loss:

$$L = {\sum }_{m = 1}^{M} {\sum }_{i = 1}^{\vert V \vert} {y}_{m , i} log {\hat{y}}_{m , i} , {s}_{m} = transformer ( \{ {h}_{i}^{m , {L}^{Δ} , Δ} \vert {v}_{i} ∈ {S}_{m} \} )$$

where V is the total item space, yₘ∈{0,1}^{|V|} is the one-hot encoded next ground-truth item of the sequence Sₘ, ŷₘ=σ(f(sₘ)) is the predicted probability distribution of the next item for the sequence Sₘ output from the linear prediction head f followed by the softmax normalization σ.

The sequential recommendation system 104 may also include second metadata embedding layer 226b in transformer 234, according to some embodiments. The second metadata embedding layer 226b may be configured for message-passing in accordance with the present disclosure. In addition, the sequential recommendation system 104 may be configured to update the second metadata embedding layer 226b, and the self-attention layer 228a by back-propagation. In addition, to maintain embedding consistency with each epoch (e.g., cycle), the first metadata embedding layer 226a and the self-attention layer 228b may be learned through momentum update.

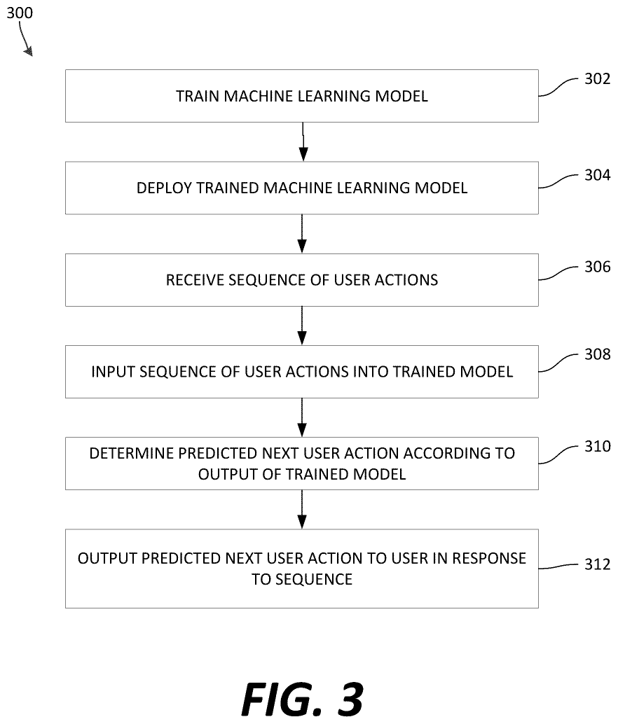

FIG. 3 is a flow chart illustrating an example method of providing a recommendation to a user based on a sequence of actions of the user. The method 300, or one or more portions of the method 300, may be performed by the system 100, and more particularly by the sequential recommendation system 104, in some embodiments.

The method 300 may include, at block 302, training a machine learning model. The machine learning model may be trained to receive, as input, a sequence of user actions and a knowledge graph respective of possible user actions (e.g., products and services selectable by the user) and to output one or more predicted next user actions, or one or more characteristics of the predicted next user action(s). For example, in some embodiments, the machine learning model may be trained to accept a sequence of documents selected by the user in a current session and a knowledge graph respective of historical user interactions with those documents and to output one or more characteristics of a predicted next document for the session. In a further example, the machine learning model may be trained to accept a sequence of products and/or services available on an e-commerce website and a knowledge graph respective of historical user co-browsing relationships between those products and/or services and to output a predicted next product or service or one or more characteristics of a predicted next product or service. According to some embodiments, training the machine learning model at block 302 may include building knowledge graphs as set forth in FIG. 2a, and training the machine learning model may include utilizing the knowledge graphs as set forth in FIG. 2b on training data such as, for example, user sequences based on user activity.

Training the machine learning model at block 302 may be performed using a set of training data that may include, for example, documents accessible through a given interface, such as a website or mobile application. The documents may be, for example, individual web pages, information pages for respective products or services, spreadsheet or database rows, text lines, etc. The training data may further include user activity through the interface, such as interaction with the documents and/or their contents or subject, that occurred before training.

The method 300 may further include, at block 304, deploying the trained machine learning model. The trained machine learning model may be deployed in conjunction with a website or mobile application, such as the website or mobile application with which the training data is associated. After deployment, each user's sequence of actions on the interface may be analyzed according to the trained machine learning model, and output based on the trained machine learning model may be provided to the user through the interface. In some embodiments, deploying the trained machine learning model at block 304, and analyzing each user's sequence of actions may include utilizing the knowledge graphs and determining context embeddings for performing next user selection predictions as set forth in FIG. 2b.

The method 300 may further include, at block 306, receiving a sequence of user actions. The sequence of user actions may be a user's interactions with the interface with which the training data used at block 302 is associated. For example, the user actions may be a sequence of documents that the user selects (e.g., clicks), navigates to, scrolls, or the contents (e.g., products and/or services) of which documents the user purchases, adds to cart, etc. within a given browsing session. In some embodiments, receiving the sequence of user actions at block 306 may correspond to receiving the user sequence 224 as set forth in FIG. 2b.

The method 300 may further include, at block 308, inputting the sequence of user actions into the deployed trained model. In some embodiments, each new user action may be input to the trained model, such that the trained model is predicting a next user action in response to each new user action, based on the sequence of prior user actions. The sequence of user actions may be of a defined length, in some embodiments. For example, in some embodiments, up to three prior user actions, in sequence, may be input to the model. In another example, all user actions within a single browsing session, or within a given time frame (e.g., one day), may be input to the model. In another example, up to a predetermined number of user actions (e.g., up to 50 user actions) without an intervening gap between actions that is greater than a threshold (e.g., a gap of one day or more between user actions may result in a new sequence of user actions) may be input to the model. In some embodiments, inputting the sequence of user actions into the deployed trained model in block 308 may include inputting the user sequence 224 to the metadata embedding module 212, self-attention module 214, context embedding module 216, transformer 234, pooling layer 238, other modules, or any combinations thereof, as set forth in FIG. 2b.

In response to the input sequence of user actions, the machine learning model may output one or more predicted next user actions, or one or more characteristics of the predicted next user action(s). For example, the machine learning model may output one or more characteristics (e.g., a plurality of characteristics) of a predicted next document, such as one or more characteristics of a product or service that is the subject of the predicted next document. For example, in an embodiment in which the documents are respective of products and services, the machine learning model may output words (e.g., unique attributes) that describe a predicted next product or service. In another embodiment, the machine learning model may output a unique identifier respective of one or more predicted next documents.

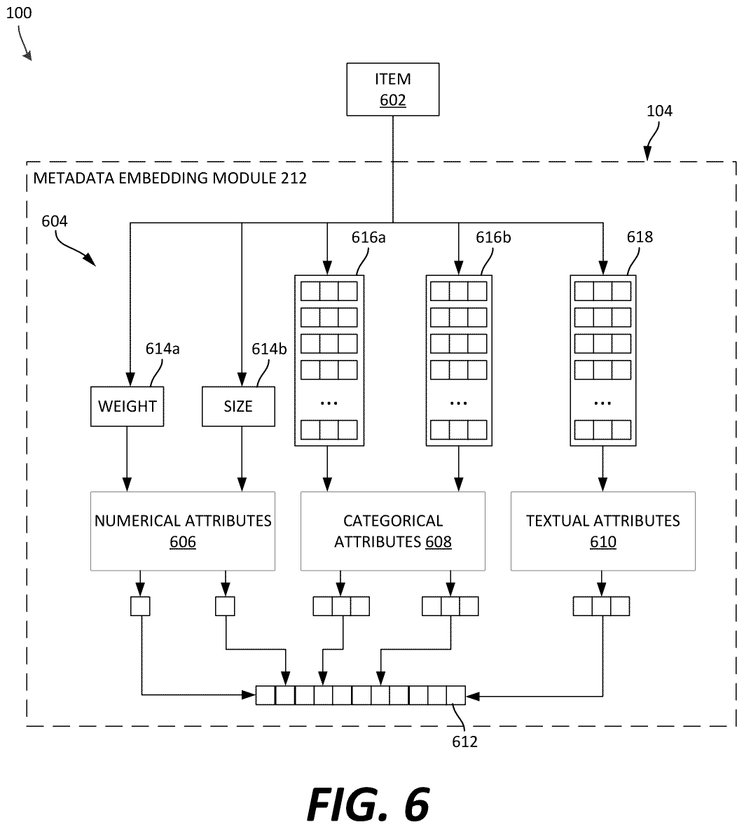

The method 300 may further include, at block 310, determining a predicted next user action based on the output of the trained machine learning model. For example, in an embodiment in which the model outputs a unique identifier of a document as the predicted next user action, that document may be designated as the predicted next user action. In another example, in an embodiment in which the machine learning model outputs characteristics of a document, or of a product or service, block 310 may include determining the document, product, or service on the interface that is most similar to the characteristics output by the model. In a further example, where the model outputs embeddings, block 310 may include determining the document, product, or service having embeddings that are most similar to the embeddings output by the model. In some embodiments, determining the predicted next user action at block 310 may include determining the prediction of the next user action as set forth in FIG. 2b. In some embodiments, determining the predicted next user action at block 310 includes encoding embeddings 612 based on the metadata 604 as set forth in FIG. 6.

The method 300 may further include, at block 312, outputting the predicted next user action(s) to the user in response to the received sequence of user events. For example, the predicted next document, or product or service that is the subject of the predicted next document, may be output to the user in the form of a page recommendation, product recommendation, service recommendation, etc., through the electronic interface. In some embodiments, block 312 may include displaying a link to the predicted next document in response to a user search. In some embodiments, block 312 may include displaying a link to the predicted next document in response to a user navigation. In some embodiments, block 312 may include displaying a link to the predicted next document in response to a user click.

In some embodiments, blocks 306, 308, 310, and 312 may be performed continuously respective of a plurality of users of an electronic interface to provide next action predictions to each of those users, responsive to each user's own activity. In some embodiments, predictions may be provided to a given user multiple times during the user's browsing or use session, such that the prediction is re-determined for multiple successive user actions in a sequence.

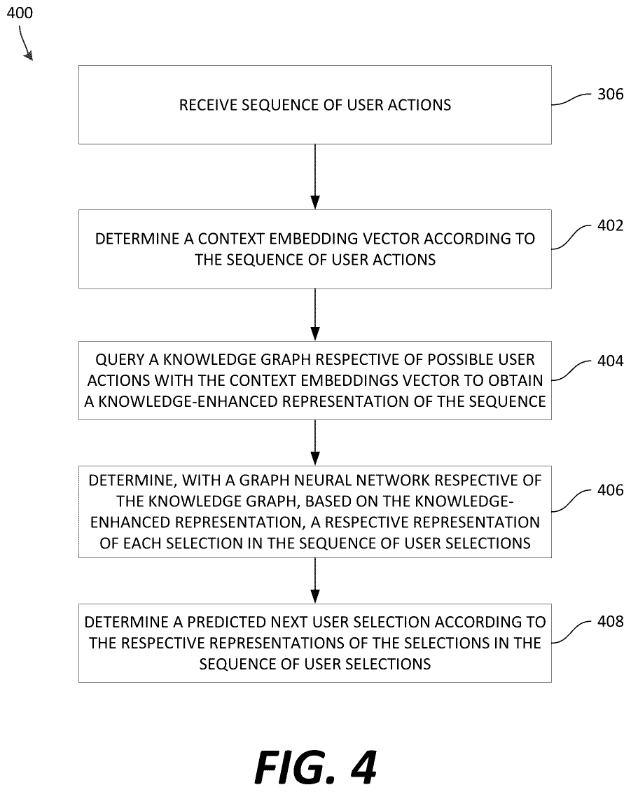

FIG. 4 is a flow chart illustrating an example method 400 of predicting a next user action in a session using a knowledge graph. The method 400, or one or more portions of the method 400, may be performed by the sequential recommendation system 104 of FIG. 1.

The method 400 may include, at block 306, receiving a sequence of user actions and, at block 402, determining a context embedding vector according to the received sequence of user actions. The context embedding vector may be determined according to a self-attention layer of a machine learning model, for example, applied to embedding vectors respective of each of the user actions in the sequence. In some embodiments, determining the context embedding vector at block 402 includes the context embedding module 216 determining the context embedding vectors at the context embeddings layer 230 as set forth in FIG. 2b. In addition, in some embodiments, the context embedding vector being determined according to the self-attention layer includes the self-attention module 214 applying self-attention at first attention layer 228 a to determine the context embeddings as set forth in FIG. 2b.

In some embodiments, block 402 may include determining a respective embedding vector for each selection in the sequence of user selections, and determining the context embeddings vector is according to the respective embeddings vector for each selection in the sequence of user selections. In some embodiments, determining the respective embedding vector for each selection in the sequence of user selections includes the metadata embedding module 212 encoding embeddings from the metadata to each item (e.g., selection) at first metadata embedding layer 226 a and the self-attention module 214 applying self-attention at first attention layer 228 a to determine the context embeddings for each selection in the user sequence 224 as set forth in FIG. 2b. In some embodiments, determining the respective embedding vector for each selection in the sequence of user selections includes extracting embedding vectors based on attributes 614, 616, 618 in metadata 604 and encoding embeddings 612 for each selection in the sequence of user selections as set forth in FIG. 6.

The method 400 may further include, at block 404, querying a knowledge graph respective of possible user actions with the context embedding vector to obtain a knowledge-enhanced representation of the sequence. Querying the knowledge graph may include, for example, performing heterogenous graph propagation using the context embedding vector. In some embodiments, querying the knowledge graph at block 404 includes the context embedding module 216 querying 220 the knowledge graph from graph module 206 and obtaining the neighborhoods as return 222 as set forth in FIG. 2b.

The method 400 may further include, at block 406, determining, with a graph neural network respective of the knowledge graph, based on the knowledge-enhanced representation, a respective representation of each action in sequence of user actions. The respective representations may be the result of the above-noted heterogenous graph propagation. Further, in some embodiments, the respective representations determined at block 406 may include representations of one or more respective neighbors in the graph for each action in the sequence. In some embodiments, determining, with the graph neural network respective of the knowledge graph, based on the knowledge-enhanced representation, the respective representation of each action in sequence of user actions includes determining, at GNN layer 232, based on the knowledge-enhanced representation, the respective representation of each action in sequence 224 of user actions as set forth in FIG. 2b.

The method 400 may further include, at block 408, determining a predicted next user action according to the respective representations determined at block 406. Block 408 may include, for example, applying a transformer-based model portion to the representations determined at block 406, which transformer-based model portion may output a predicted next action from the graph of possible actions. In some embodiments, determining the predicted next user action according to the respective representations at block 408 includes determining the prediction as set forth in FIG. 2b.

In some embodiments, one or more of the user actions in the sequence of user actions received at block 306 may include an action that is not included in the knowledge graph. In such embodiments, the method 400 may include generating an embedding vector representation of the action. That embedding vector representation may be used to generate the context embedding vector at block 402. In some embodiments, generating the embedding vector representations of the action includes the context embedding module 216 generating the context embedding vector at context embeddings layer 230 as set forth in FIG. 2b.

Determining a predicted next user action according to the present disclosure presents advantages over known methods and systems. By incorporating a knowledge graph representative of known connections between user selections, where those connections are established by user browsing actions, a model according to the present disclosure may more accurately determine the user's intent relative to known models. This relative accuracy improvement may be particularly pronounced early in the user browsing sequence, in some embodiments.

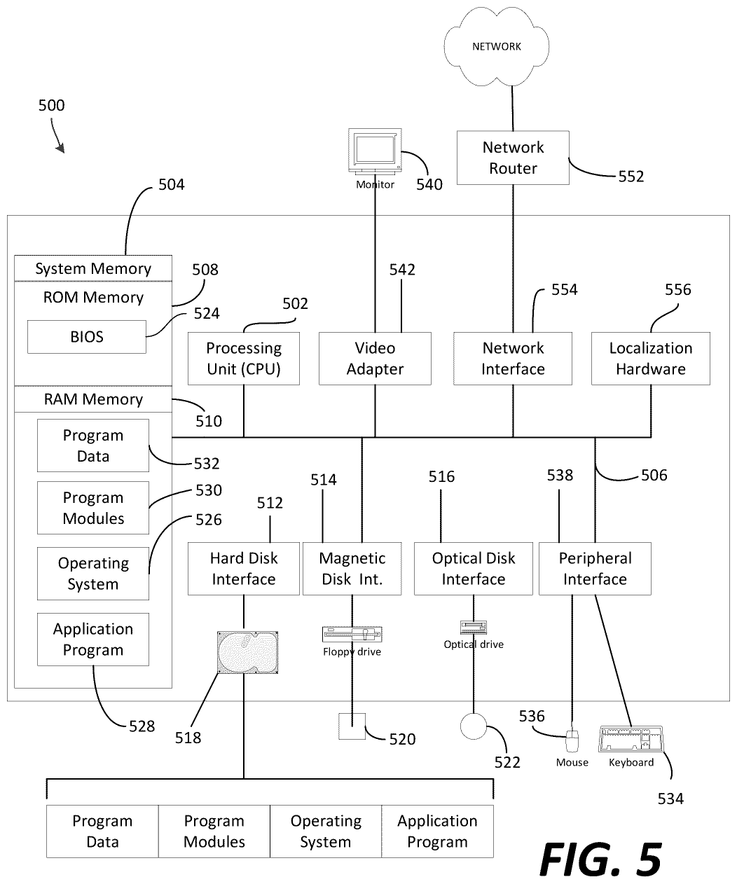

FIG. 5 is a diagrammatic view of an example embodiment of a user computing environment that includes a general purpose computing system environment 500, such as a desktop computer, laptop, smartphone, tablet, or any other such device having the ability to execute instructions, such as those stored within a non-transient, computer-readable medium. Furthermore, while described and illustrated in the context of a single computing system 500, those skilled in the art will also appreciate that the various tasks described hereinafter may be practiced in a distributed environment having multiple computing systems 500 linked via a local or wide-area network in which the executable instructions may be associated with and/or executed by one or more of multiple computing systems 500.

In its most basic configuration, computing system environment 500 typically includes at least one processing unit 502 and at least one memory 504, which may be linked via a bus 506. Depending on the exact configuration and type of computing system environment, memory 504 may be volatile (such as RAM 510), non-volatile (such as ROM 508, flash memory, etc.) or some combination of the two. Computing system environment 500 may have additional features and/or functionality. For example, computing system environment 500 may also include additional storage (removable and/or non-removable) including, but not limited to, magnetic or optical disks, tape drives and/or flash drives. Such additional memory devices may be made accessible to the computing system environment 500 by means of, for example, a hard disk drive interface 512, a magnetic disk drive interface 514, and/or an optical disk drive interface 516. As will be understood, these devices, which would be linked to the system bus 506, respectively, allow for reading from and writing to a hard disk 512, reading from or writing to a removable magnetic disk 520, and/or for reading from or writing to a removable optical disk 522, such as a CD/DVD ROM or other optical media. The drive interfaces and their associated computer-readable media allow for the nonvolatile storage of computer readable instructions, data structures, program modules and other data for the computing system environment 500. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 500.

A number of program modules may be stored in one or more of the memory/media devices. For example, a basic input/output system (BIOS) 524, containing the basic routines that help to transfer information between elements within the computing system environment 500, such as during start-up, may be stored in ROM 508. Similarly, RAM 510, hard drive 512, and/or peripheral memory devices may be used to store computer executable instructions comprising an operating system 526, one or more applications programs 528 (which may include the functionality of the category prediction system 104 of FIG. 1 or one or more of its functional modules 106, 108, 110 for example), other program modules 530, and/or program data 532. Still further, computer-executable instructions may be downloaded to the computing environment 500 as needed, for example, via a network connection.

An end-user may enter commands and information into the computing system environment 500 through input devices such as a keyboard 534 and/or a pointing device 536. While not illustrated, other input devices may include a microphone, a joystick, a game pad, a scanner, etc. These and other input devices would typically be connected to the processing unit 502 by means of a peripheral interface 538 which, in turn, would be coupled to bus 506. Input devices may be directly or indirectly connected to processor 502 via interfaces such as, for example, a parallel port, game port, firewire, or a universal serial bus (USB). To view information from the computing system environment 500, a monitor 540 or other type of display device may also be connected to bus 506 via an interface, such as via video adapter 542. In addition to the monitor 540, the computing system environment 500 may also include other peripheral output devices, not shown, such as speakers and printers.

The computing system environment 500 may also utilize logical connections to one or more computing system environments. Communications between the computing system environment 500 and the remote computing system environment may be exchanged via a further processing device, such a network router 552, that is responsible for network routing. Communications with the network router 552 may be performed via a network interface component 554. Thus, within such a networked environment, e.g., the Internet, World Wide Web, LAN, or other like type of wired or wireless network, it will be appreciated that program modules depicted relative to the computing system environment 500, or portions thereof, may be stored in the memory storage device(s) of the computing system environment 500.

The computing system environment 500 may also include localization hardware 556 for determining a location of the computing system environment 500. In embodiments, the localization hardware 556 may include, for example only, a GPS antenna, an RFID chip or reader, a WiFi antenna, or other computing hardware that may be used to capture or transmit signals that may be used to determine the location of the computing system environment 500.

The computing environment 500, or portions thereof, may comprise one or more components of the system 100 of FIG. 1, in embodiments.

FIG. 6 is a block diagram illustrating a non-limiting example of the sequential recommendation system 104 performing the encoding of metadata embeddings, according to some embodiments.

According to some embodiments, the system 100 and the sequential recommendation system 104 may include the metadata embedding module 212. The metadata embedding module 212 may be configured to encode embeddings for a given item 602 based on the item's metadata. The given item may correspond, for example, to items 210 in FIG. 2b, and based on the metadata 604 of the item 602. That is, the metadata embedding module 212 may, for a given sequence such as, for example, sequence 224 in FIG. 2b, encode embeddings for the item based on the item's metadata.

The metadata embedding module 212 enables items sharing the same attributes to be similarly encoded. Hence, even for cold-start items selected by a user during a sequence, such items may share the same sub-embeddings with already encoded items if they share the same metadata attributes, thereby enabling improved next item recommendation by the sequential recommendation system 104 and alleviating the issue of lower optimalization which may be typically encountered in conventional systems providing item recommendation due to less supervision in training sequences.

The given item 602 may include metadata 604, and the metadata 604 may include therein different attributes. In some embodiments, the metadata 604 for the item 602 may include one or more attributes. In other embodiments, the metadata 604 for the item 602 may include a plurality of different attributes. The metadata embedding module 212 may, for the item 602, apply the one or more models and/or one or more techniques in accordance with the present disclosure to the metadata 604 to identify the different attributes associated with the item 602 based on the metadata 604, and encode the attributes extracted from the metadata 604 into an item embedding 612.

Referring to FIG. 6, the metadata embedding module 212 may include therein numerical attribute module 606, categorical attribute module 608, and textual attribute module 610. In some embodiments, the metadata embedding module 212 may include therein one or more modules including, but not limited to, numerical attribute module 606, categorical attribute module 608, textual attribute module 610, other modules, or any combinations thereof.

The numerical attribute module 606 may extract, according to some embodiments, attributes 614a, and attributes 614b, which may hereinafter be referred to as attributes 614, from the metadata 604. The metadata embedding module 212 and the numerical attribute module 606 may then directly encode the attributes 614 as vector values into embedding 612. For example, the item may include numerical data corresponding to a weight and size of the item and such numerical data may directly be encoded into the embedding for the item. It is to be appreciated by those having ordinary skill in the art that the metadata 604 for a given item is not intended to be limited to attributes 614a and attributes 614b, as shown in FIG. 6, and the metadata 604 may therefore include one or more different attributes including attributes 614 a, attributes 614 b, one or more other attributes, or any combinations thereof.

The categorical attribute module 608 may extract, according to some embodiments, attributes 616a, and attributes 616b, which may hereinafter be referred to as attributes 616, from the metadata 604. The metadata embedding module 212 and the categorical attribute module 608 may then parse through the different categories and identify the attributes 616 corresponding to the item 602. Once the attributes 616 are identified, the categorical attribute module 608 may encode the attributes 614 as vector values into embedding 612.

In this regard, for each categorical attribute C={C_{c}}_{c=1}^{|C|}, the sequential recommendation system 104 may generate a unique embedding matrix, which may be initialized according to E^{C}∈R^{|C|×d}^{^{c}}, dc where e_{c}^{C} represents the embedding when item's categorical attribute C=c. For example, the item metadata may include data indicative that the item falls under the category of home accents and also under the category of sculptures, and these categories may be encoded into the embedding for the item. It is to be appreciated by those having ordinary skill in the art that the metadata 604 for a given item is not intended to be limited to categorical attributes 616 a, and attributes 616 b, as shown in FIG. 6, and the metadata 604 may therefore include one or more different attributes including attributes 616 a, attributes 616 b, one or more other categorical attributes, or any combinations thereof.

The textual attribute module 610 may extract, according to some embodiments, attributes 618 from the metadata 604. In some embodiments, the metadata 604 may include text data and the attributes 618 may be extracted from the text data by textual attribute module 610. In some embodiments, the metadata embedding module 212 and the textual attribute module 610 may apply one or more models such as, for example, NLP models to the metadata 604 to identify sentences within the metadata 604 and may then determine the title/description embeddings by mean pooling over the embeddings of all words in the sentence(s). For each textual attribute 618 such as, for example, item title and description that can be represented as a sentence, the sequential recommendation system 104 may construct a word embedding matrix e^{W}∈r^{|w|×d}^{^{W}}, where row w corresponds to the embedding e_{w}^{W} of the unique word w∈W. Note that, in some embodiments, pre-trained NLP models may not be preferred here to avoid capturing noisy semantic signals in the data. For example, even though silver sinks and creamy white stones share semantic-similar colors, they are purposed for different decorating intentions. In some embodiments, the textual attribute module 610 of the metadata embedding module 212 may utilize token-based embedding, where such noisy semantic signals may be avoided since they correspond to different word embeddings relative each other.

The metadata embedding module 212 may, based on the outputs from the attribute modules therein, produce a final embedding 612 (eᵢ) as output. That is, the final embedding eᵢ of each item vᵢ may be generated by concatenating all different types of feature vectors from the different modules. In some embodiments, the feature vectors output from the numerical attribute module 606, the categorical attribute module 608, and the textual attribute module 610 may be concatenated to produce the final embedding 612. In this regard, the metadata embedding module 212 applied by the sequential recommendation system 104 enables items sharing the same or similar attributes to be similarly encoded relative the other item as compared to conventional approaches that encode items based only on item IDs.

In some embodiments, a method for predicting a next user selection in an electronic user interface includes receiving a sequence of user selections through the electronic user interface; determining a context embedding vector according to the sequence of user selections; querying a knowledge graph, the knowledge graph respective of a plurality of possible user selections, with the context embedding vector, to obtain a knowledge-enhanced representation of the sequence of user selections; determining, with a graph neural network respective of the knowledge graph, based on the knowledge-enhanced representation, a respective representation of each user selection in the sequence of user selections; and determining a predicted next user selection according to the respective representation of the user selection in the sequence of user selections.

In some embodiments, determining the predicted next user selection according to the respective representations of the user selection in the sequence of user selections includes inputting the respective representations of the user selection into a transformer-based encoder.

In some embodiments, the method further includes determining a respective embeddings vector for each user selection in the sequence of user selections. In some embodiments, determining the context embedding vector is according to the respective embeddings vector for each user selection in the sequence of user selections.

In some embodiments, one or more user selections in the sequence of user selections are not included in the knowledge graph.

In some embodiments, the method further includes building the knowledge graph according to session relationships of possible user selections.

In some embodiments, the session relationships include one or more of: co-views; co-purchases; or co-view purchases.

In some embodiments, a system for predicting a next user selection includes a processor; and a memory including a non-transitory computer readable medium having stored therein one or more instructions executable by the processor to perform operations including train a model for predicting the next user selection; deploy the trained model; receive a sequence of user actions through an electronics user interface; input the sequence of user actions into the trained model to generate an output; determine a predicted next user action based on the output of the trained model; and output the predicted next user action in response to the sequence of user actions.

In some embodiments, training the model further includes receive, as input, the sequence of user actions and a knowledge graph respective of possible user actions. In some embodiments, the predicted next user action is determined based on the knowledge graph respective of the possible user actions.

In some embodiments, inputting the sequence of user actions into the trained model further includes inputting each new user action into the trained model, such that the trained model is predicting a next user action in response to each new user action, based on a sequence of prior user actions.

In some embodiments, receiving the sequence of user actions further includes determining a context embedding vector according to the sequence of user actions; querying a knowledge graph, the knowledge graph respective of a plurality of possible user actions, with the context embedding vector, to obtain a knowledge-enhanced representation of the sequence of user actions; determining, with a graph neural network respective of the knowledge graph, based on the knowledge-enhanced representation, a respective representation of each user action in the sequence of user actions; and determining a predicted next user action according to the respective representation of the selections in the sequence of user actions.

In some embodiments, determining the predicted next user action according to the respective representations of the actions in the sequence of user actions includes inputting the respective representations of the user actions into a transformer-based encoder.

In some embodiments, the processor further performs operations including determining a respective embeddings vector for each action in the sequence of user actions. In some embodiments, determining the context embedding vector is according to the respective embeddings vector for each action in the sequence of user actions.

In some embodiments, one or more of the user actions in the sequence of user actions are not included in the knowledge graph.

In some embodiments, the processor further performs operations including building the knowledge graph according to session relationships of the possible user actions.

In some embodiments, the session relationships include one or more of: co-views; co-purchases; or co-view purchases.

In some embodiments, a non-transitory computer readable medium having stored therein instructions that are executable by a processor of a computing device to cause the computing device to perform operations including: receiving a sequence of user selections through an electronic user interface; determining a context embedding vector according to the sequence of user selections; querying a knowledge graph, the knowledge graph respective of a plurality of possible user selections, with the context embedding vector, to obtain a knowledge-enhanced representation of the sequence; determining, with a graph neural network respective of the knowledge graph, based on the knowledge-enhanced representation, a respective representation of each selection in the sequence of user selections; and determining a predicted next user selection according to the respective representations of the selections in the sequence of user selections.

In some embodiments, determining the predicted next user selection according to the respective representations of the user selections in the sequence of user selections includes inputting the respective representations of the user selections into a transformer-based encoder.

In some embodiments, the computing device further performs operations including determining a respective embeddings vector for each user selection in the sequence of user selections. In some embodiments, determining the context embeddings vector is according to the respective embeddings vector for each user selection in the sequence of user selections. In some embodiments, one or more of the user selections in the sequence of user selections are not included in the knowledge graph.

In some embodiments, the computing device further performs operations including building the knowledge graph according to session relationships of the possible user selections.

In some embodiments, the session relationships include one or more of: co-views; co-purchases; or co-view purchases.

While this disclosure has described certain embodiments, it will be understood that the claims are not intended to be limited to these embodiments except as explicitly recited in the claims. On the contrary, the instant disclosure is intended to cover alternatives, modifications and equivalents, which may be included within the spirit and scope of the disclosure. Furthermore, in the detailed description of the present disclosure, numerous specific details are set forth in order to provide a thorough understanding of the disclosed embodiments. However, it will be obvious to one of ordinary skill in the art that systems and methods consistent with this disclosure may be practiced without these specific details. In other instances, well known methods, procedures, components, and circuits have not been described in detail as not to unnecessarily obscure various aspects of the present disclosure.

Some portions of the detailed descriptions of this disclosure have been presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic data capable of being stored, transferred, combined, compared, and otherwise manipulated in a computer system or similar electronic computing device. For reasons of convenience, and with reference to common usage, such data is referred to as bits, values, elements, symbols, characters, terms, numbers, or the like, with reference to various presently disclosed embodiments. It should be borne in mind, however, that these terms are to be interpreted as referencing physical manipulations and quantities and are merely convenient labels that should be interpreted further in view of terms commonly used in the art. Unless specifically stated otherwise, as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers, or other such information storage, transmission, or display devices as described herein or otherwise understood to one of ordinary skill in the art.

What is claimed is:

1. A method for predicting a next user selection in an electronic user interface, the method comprising:
receiving a sequence of user selections through the electronic user interface;
determining a context embedding vector according to the sequence of user selections;
querying a knowledge graph, the knowledge graph respective of a plurality of possible user selections, with the context embedding vector, to obtain a knowledge-enhanced representation of the sequence of user selections;
determining, with a graph neural network respective of the knowledge graph, based on the knowledge-enhanced representation, a respective representation of each user selection in the sequence of user selections; and
determining a predicted next user selection according to the respective representation of the user selection in the sequence of user selections.

2. The method of claim 1, wherein determining the predicted next user selection according to the respective representations of the user selection in the sequence of user selections comprises inputting the respective representations of the user selection into a transformer-based encoder.

3. The method of claim 1, further comprising:
determining a respective embeddings vector for each user selection in the sequence of user selections;
wherein determining the context embedding vector is according to the respective embeddings vector for each user selection in the sequence of user selections.

4. The method of claim 3, wherein one or more user selections in the sequence of user selections are not included in the knowledge graph.

5. The method of claim 1, further comprising:
building the knowledge graph according to session relationships of possible user selections.

6. The method of claim 5, wherein the session relationships comprise one or more of:
co-views;
co-purchases; or
co-view purchases.

7. A system for predicting a next user selection, the system comprising:
a processor; and
a memory comprising a non-transitory computer readable medium having stored therein one or more instructions executable by the processor to perform operations comprising:
train a model for predicting the next user selection;
deploy the trained model;
receive a sequence of user actions through an electronics user interface;
input the sequence of user actions into the trained model to generate an output;
determine a predicted next user action based on the output of the trained model; and
output the predicted next user action in response to the sequence of user actions.

8. The system of claim 7, wherein training the model further comprises:
receive, as input, the sequence of user actions and a knowledge graph respective of possible user actions;
wherein the predicted next user action is determined based on the knowledge graph respective of the possible user actions.

9. The system of claim 7, wherein inputting the sequence of user actions into the trained model further comprises:
inputting each new user action into the trained model, such that the trained model is predicting a next user action in response to each new user action, based on a sequence of prior user actions.

10. The system of claim 7, wherein receiving the sequence of user actions further comprises:
determining a context embedding vector according to the sequence of user actions;
querying a knowledge graph, the knowledge graph respective of a plurality of possible user actions, with the context embedding vector, to obtain a knowledge-enhanced representation of the sequence of user actions;
determining, with a graph neural network respective of the knowledge graph, based on the knowledge-enhanced representation, a respective representation of each user action in the sequence of user actions; and
determining a predicted next user action according to the respective representation of the selections in the sequence of user actions.

11. The system of claim 10, wherein determining the predicted next user action according to the respective representations of the actions in the sequence of user actions comprises inputting the respective representations of the user actions into a transformer-based encoder.

12. The system of claim 10, wherein the processor further perform operations comprising:
determining a respective embeddings vector for each action in the sequence of user actions;
wherein determining the context embedding vector is according to the respective embeddings vector for each action in the sequence of user actions.

13. The system of claim 12, wherein one or more of the user actions in the sequence of user actions are not included in the knowledge graph.

14. The system of claim 10, wherein the processor further perform operations comprising:
building the knowledge graph according to session relationships of the possible user actions.

15. The system of claim 14, wherein the session relationships comprise one or more of:
co-views;
co-purchases; or
co-view purchases.

16. A non-transitory computer readable medium having stored therein instructions that are executable by a processor of a computing device to cause the computing device to perform operations comprising:
receiving a sequence of user selections through an electronic user interface;
determining a context embedding vector according to the sequence of user selections;
querying a knowledge graph, the knowledge graph respective of a plurality of possible user selections, with the context embedding vector, to obtain a knowledge-enhanced representation of the sequence;
determining, with a graph neural network respective of the knowledge graph, based on the knowledge-enhanced representation, a respective representation of each selection in the sequence of user selections; and
determining a predicted next user selection according to the respective representations of the selections in the sequence of user selections.

17. The computing device of claim 16, wherein determining the predicted next user selection according to the respective representations of the user selections in the sequence of user selections comprises inputting the respective representations of the user selections into a transformer-based encoder.

18. The computing device of claim 16, wherein the computing device further performs operations comprising:
determining a respective embeddings vector for each user selection in the sequence of user selections; and
wherein determining the context embeddings vector is according to the respective embeddings vector for each user selection in the sequence of user selections;
wherein one or more of the user selections in the sequence of user selections are not included in the knowledge graph.

19. The computing device of claim 16, wherein the computing device further perform operations comprising:
building the knowledge graph according to session relationships of the possible user selections.

20. The computing device of claim 19, wherein the session relationships comprise one or more of:
co-views;
co-purchases; or
co-view purchases.
